(19) United States
(12) Patent Application Publication
(10) Pub. No.: US 2025/0013695 A1
(43) Pub. Date: Jan. 9, 2025

(54) SEARCH ASSISTANCE DEVICE, SEARCH ASSISTANCE METHOD, AND RECORDING MEDIUM

(71) Applicant: NEC Corporation, Tokyo (JP)

(72) Inventors: Toshihiko FUJII, Tokyo (JP); Kohei SUGA, Tokyo (JP)

(73) Assignee: NEC Corporation, Tokyo (JP)

(21) Appl. No.: 18/732,930

(22) Filed: Jun. 4, 2024

(30) Foreign Application Priority Data
Jul. 5, 2023 (JP) 2023-110374

(51) Int. Cl. G06F 16/903

(52) U.S. Cl. CPC G06F 16/90335

(57) ABSTRACT

The search assistance device receives a first input related to an article as a search target, specifies a statistical number candidate into which the search target is classified based on the first input and classification information for each statistical number included in a statistical number group having a hierarchical structure, and outputs first information requesting a second input related to the search target to be additionally input in a case where a plurality of statistical number candidates is specified, and the statistical number candidate.

This application is based upon and claims the benefit of priority from Japanese Patent Application No. 2023-110374, filed on Jul. 5, 2023, the disclosure of which is incorporated herein in its entirety by reference.

### TECHNICAL FIELD

The present disclosure relates to a search assistance device and the like.

### BACKGROUND ART

At the time of importing or exporting an article, it is necessary to assign a statistical number to the article. For example, in Japan, Japan Customs discloses an applied Customs Tariff Schedule, Explanations, Classification Regulations, Case Studies, and the like (e.g., NPL 1 (Customs Import and Export Procedures, [online], [searched on Jun. 21, 2023], Internet <https://www.customs.go.jp/tsukan/index.htm>)). In the applied Customs Tariff Schedule, a statistical number is described in association with an article name represented by the statistical number.

For example, JP 2022-54527 A describes that, with invoice information for a specific product as an input, each of a plurality of models presents a degree of suitability of a statistical number that can be applied to the specific product.

### SUMMARY

An object of the present disclosure is to provide a search assistance device and the like capable of easily finding a statistical number suitable for an article.

A search assistance device according to an aspect of the present disclosure includes:
a reception means for receiving a first input related to an article as a search target;
a specification means for specifying a statistical number candidate into which the search target is classified based on the first input and classification information for each statistical number included in a statistical number group having a hierarchical structure; and
an output means for outputting first information requesting a second input related to the search target to be additionally input in a case where a plurality of statistical number candidates is specified by the specification means, and the statistical number candidate.

A search assistance method according to an aspect of the present disclosure includes the steps of, by a computer:
receiving a first input related to an article as a search target;
specifying a statistical number candidate into which the search target is classified based on the first input and classification information for each statistical number included in a statistical number group having a hierarchical structure; and
outputting first information requesting a second input related to the search target to be additionally input in a case where a plurality of statistical number candidates is specified, and the statistical number candidate.

A program according to an aspect of the present disclosure causes a computer to execute the processes of:
receiving a first input related to an article as a search target;
specifying a statistical number candidate into which the search target is classified based on the first input and classification information for each statistical number included in a statistical number group having a hierarchical structure; and
outputting first information requesting a second input related to the search target to be additionally input in a case where a plurality of statistical number candidates is specified, and the statistical number candidate.

Each program may be stored in a non-transitory computer-readable recording medium.

### BRIEF DESCRIPTION OF THE DRAWINGS

Exemplary features and advantages of the present disclosure will become apparent from the following detailed description when taken with the accompanying drawings in which:

FIG. 1 is an explanatory diagram of an HS code;

FIG. 2 is an explanatory diagram illustrating an example of an HS code group having a hierarchical structure;

FIG. 3 is a block diagram illustrating a configuration example of a search assistance device according to the present disclosure;

FIG. 4 is a flowchart illustrating an operation example of the search assistance device;

FIG. 5 is an explanatory diagram illustrating an example of connection between the search assistance device and another device;

FIG. 6 is a block diagram illustrating configuration examples of a search assistance device and a terminal device according to the present disclosure;

FIG. 7A is an explanatory diagram illustrating an example of a screen capable of receiving a first input;

FIG. 7B is an explanatory diagram illustrating an example of a screen to which a first input and an HS code of a higher hierarchy are input;

FIG. 8 is an explanatory diagram illustrating a schematic example of a process of specifying an HS code candidate;

FIG. 9 is an explanatory diagram illustrating an example in which an HS code candidate for a chapter hierarchy is specified using a large-scale language model;

FIG. 10 is an explanatory diagram illustrating an example in which an HS code candidate for a heading hierarchy is specified using a large-scale language model;

FIG. 11 is an explanatory diagram illustrating another example in which an HS code candidate for a heading hierarchy is specified using a large-scale language model;

FIG. 12 is an explanatory diagram illustrating an example in which an HS code candidate and an AI question are displayed on the same screen;

FIG. 13 is an explanatory diagram illustrating Example 1 in which detailed information related to Heading “6111” is displayed;

FIG. 14 is an explanatory diagram illustrating Example 2 in which detailed information related to Heading “6111” is displayed;

FIG. 15 is an explanatory diagram illustrating an example in which an HS code of a heading is associated with a question ID;

FIG. 16 is an explanatory diagram illustrating an example in which second information indicating a reason why a second input requested by a question is necessary is displayed;

FIG. 17 is an explanatory diagram illustrating an example in which an HS code candidate is displayed when a second input, which is an answer to a question, is input;

FIG. 18 is an explanatory diagram illustrating an example in which a screen including an answer input field for a question is displayed;

FIG. 19 is an explanatory diagram illustrating an example in which an answer input field for a question and information related to a heading for which the question has occurred are displayed;

FIG. 20 is a flowchart illustrating an operation example of the search assistance device; and

FIG. 21 is an explanatory diagram illustrating a hardware configuration example of a computer.

### EXAMPLE EMBODIMENT

Hereinafter, example embodiments of a search assistance device, a search assistance method, a program, and a non-transitory recording medium recording the program according to the present disclosure will be described in detail with reference to the drawings. These example embodiments do not limit the technology disclosed herein.

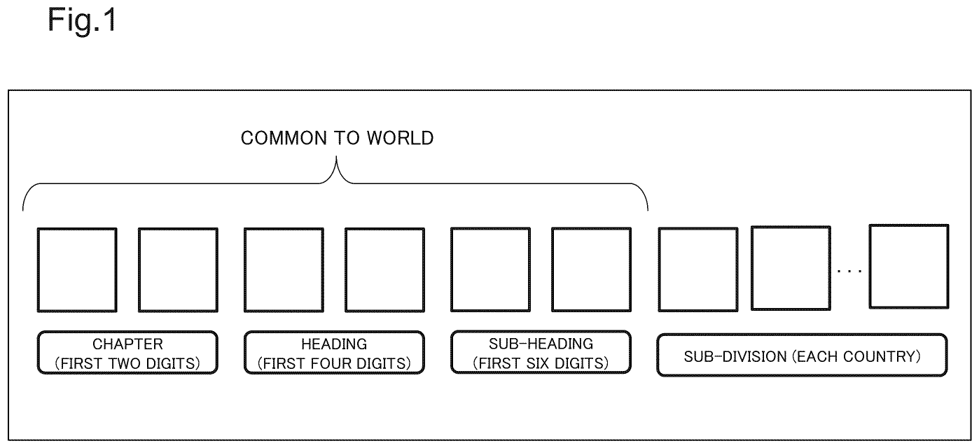

In the following example embodiments, a statistical number may be referred to as a harmonized system (HS) code. HS codes and article names used in the following description are obtained from the applied Customs Tariff Schedule published by Customs (Source: https://www.customs.go.jp/yusyutu/2023_04_01/index.htm). As an explanation for the HS code used in the following description, an explanation for Chapter “61” published by Customs will be used (Source: https://www.customs.go.jp/tariff/kaisetu/data/61r.pdf). Here, the HS code will be briefly described with reference to FIG. 1. FIG. 1 is an explanatory diagram of an HS code. The HS code is a code number defined based on the International Convention on the Harmonized Commodity Description and Coding System. The HS codes broadly categorize trade target items into 21 “sections”, each being expressed with 6 or more digits. The number common to the world is up to six digits, and any number of digits may be added to the six digits after the six digits by each country. Of the six digits, the first two digits are referred to as a chapter, the first four digits including the chapter are referred to as a heading, and the first six digits including the heading are referred to as a sub-heading. In FIG. 1, it is illustrated an example that an HS code is expressed as a 9-digit number. For example, the first nine digits including the sub-heading are referred to as a sub-division. In the present example embodiment, an example for searching for a 9-digit HS code will be described.

Here, the HS codes have a tree structure. That is, the HS code group can be represented by a hierarchical structure. An example of the HS code group having a hierarchical structure will be described.

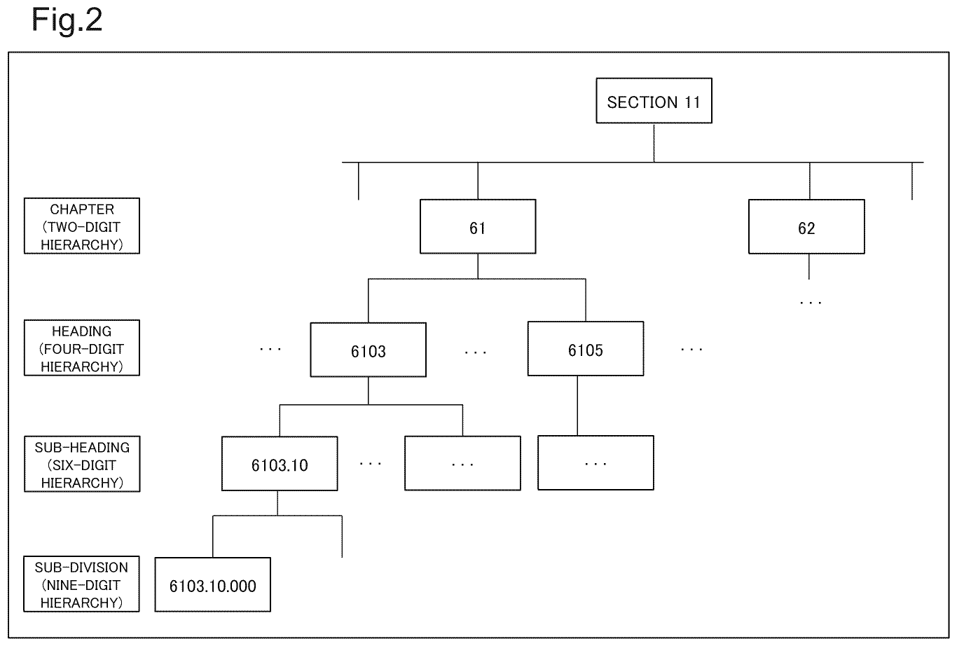

FIG. 2 is an explanatory diagram illustrating an example of an HS code group having a hierarchical structure. In FIG. 2, a case where chapters of HS codes are “61” and “62” will be described by taking some of HS codes having a hierarchical structure as an example. When the chapter is “61”, the heading is one of “6101” to “6117”. When the heading is “6103”, the sub-heading is “6103.10” or the like. When the sub-heading is “6103.10”, the hierarchy of sub-division is “6103.10.000” or the like. For example, a hierarchy one level lower than a chapter hierarchy is a heading hierarchy, and a hierarchy two levels lower than the chapter hierarchy is a sub-heading hierarchy. A hierarchy one level lower than the heading hierarchy is the sub-heading hierarchy, and a hierarchy two levels lower than the heading hierarchy is a sub-division hierarchy. The chapter hierarchy is also referred to as a two-digit hierarchy, the heading hierarchy is also referred to as a four-digit hierarchy, the sub-heading hierarchy is also referred to as a six-digit hierarchy, and the sub-division hierarchy is also referred to as a nine-digit hierarchy.

Furthermore, a hierarchy higher than the chapter hierarchy includes a section. For example, Chapters “61” and “62” are included in Section “11”.

In addition, as described above, Japan Customs discloses the applied Customs Tariff Schedule, Chapter Notes, Explanations, Classification Regulations, and Case Studies. For example, the notes concerning the chapter are provided in the Chapter Notes. The explanations for the headings are provided in the Explanations. Further, in the Explanations, article names associated to the sub-headings in hierarchies lower than each heading hierarchy are provided.

### First Example Embodiment

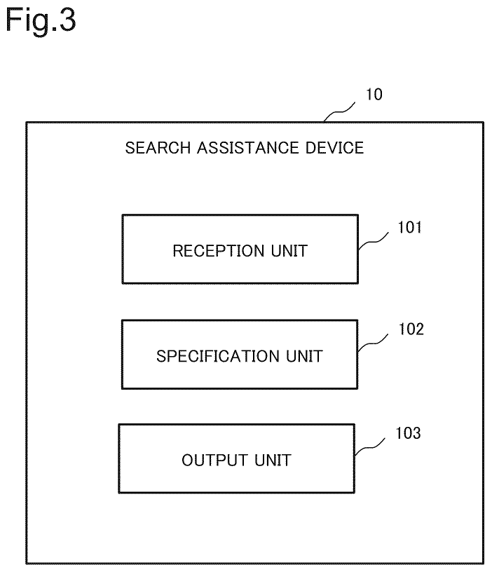

First, a first example embodiment will be described. In the first example embodiment, an example of a basic function of a search assistance device will be described. FIG. 3 is a first block diagram illustrating a configuration example of a search assistance device 10 according to the present disclosure. The search assistance device 10 includes a reception unit 101, a specification unit 102, and an output unit 103.

The reception unit 101 receives a first input related to an article as a search target. For example, the reception unit 101 may receive a keyword or the like related to the article as the search target. For example, the reception unit 101 may receive a keyword input in an input field displayed on a terminal device of a user as the first input.

The specification unit 102 specifies an HS code candidate into which the search target is classified based on the first input and classification information for each HS code included in the HS code group having the hierarchical structure. The classification information is, for example, chapter notes, article names in headings, explanations for headings, and the like. For example, in a case where the HS code group is narrowed down to HS codes included in the chapter hierarchy, the classification information of the HS codes may be chapter notes and article names in headings. In a case where the HS code group is narrowed down to HS codes included in the heading hierarchy, the classification information of the HS codes may be, for example, chapter notes and explanations for headings.

Specifically, the specification unit 102 may specify an HS code candidate using, for example, a large-scale language model. As the large-scale language model, a generative pretrained transformer (GPT) or the like may be used. More specifically, for example, the specification unit 102 may specify an HS code candidate by giving the first input and the classification information for each HS code to the large-scale language model.

In a case where a plurality of HS code candidates can be specified by the specification unit 102, the output unit 103 outputs first information requesting a second input related to the search target to be additionally input and the HS code candidates. For example, the first information is information requesting an additional input of information necessary for determining whether the search target is classified into the HS code candidate. More specifically, for example, the first information may represent a question. That is, for example, the first information may be information representing a question for narrowing down the plurality of HS code candidates into an HS code candidate into which the search target is classified.

An output method of the output unit 103 is not particularly limited. For example, the output unit 103 displays the first information and the HS code candidates on the terminal device of the user. The output unit 103 only needs to display the first information and the HS code candidates on the terminal device of the user. Then, the terminal device of the user may display the first information and the HS code candidates, for example, according to the control by the output unit 103.

### (Flowchart)

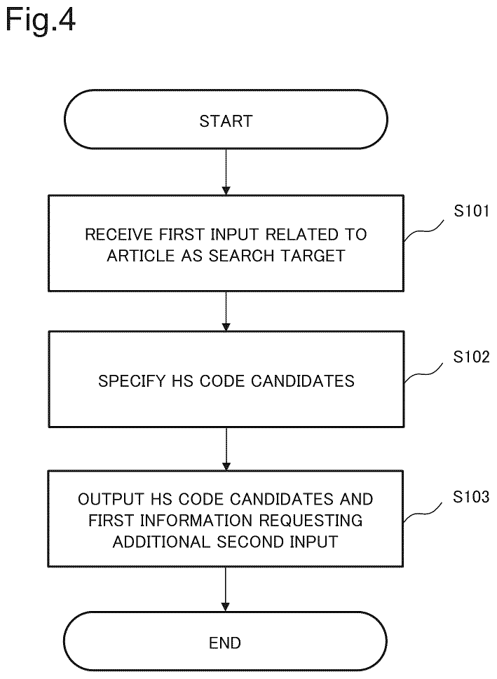

FIG. 4 is a flowchart illustrating an operation example of the search assistance device 10. The reception unit 101 receives a first input related to an article as a search target (step S101). The specification unit 102 specifies HS code candidates based on the first input and classification information for each HS code (step S102). Then, the output unit 103 outputs the HS code candidates and first information related to an HS code candidate and requesting an additional second input (step S103). Then, the search assistance device 10 ends a series of processes.

For example, in a case where a customs officer assigns an HS code to an article, information related to the article may be insufficient. For example, a customs officer needs to check information related to an article in more detail with a manufacturer, a customer, or the like, but does not know what information needs to be specifically checked concerning the article, and it is expected that interactions between the customs officer and the manufacturer, the customer, or the like will increase. In this way, it takes time and effort for a user such as a customs engineer.

In the first example embodiment, when receiving a first input related to an article as a search target, the search assistance device 10 specifies an HS code candidate based on the first input and classification information for each HS code. Then, in a case where a plurality of HS code candidates is specified, the search assistance device 10 outputs first information requesting related to an HS code candidate and an additional second input and the HS code candidates. By checking the information requesting an additional input and related to an HS code candidate, the user can easily input additional information related to the search target for classifying the search target. Accordingly, it is possible to easily find the HS code suitable for the article. Therefore, it is possible to know what kind of information needs to be checked for the article and to save the user's time and effort.

### Second Example Embodiment

Next, the second example embodiment will be described in detail with reference to the drawings. In the second example embodiment, an example will be described in detail in which first information requesting an additional input of information necessary for specifying whether the search target is classified into an HS code candidate and second information indicating a reason why a second input requested by a question that is the first information is necessary are displayed. In addition, in the second example embodiment, an example will be described in which the large-scale language model is used to determine whether to classify the search target into an HS code. Hereinafter, description overlapping with what has been described above will be omitted unless the omission obscures the description of the second example embodiment.

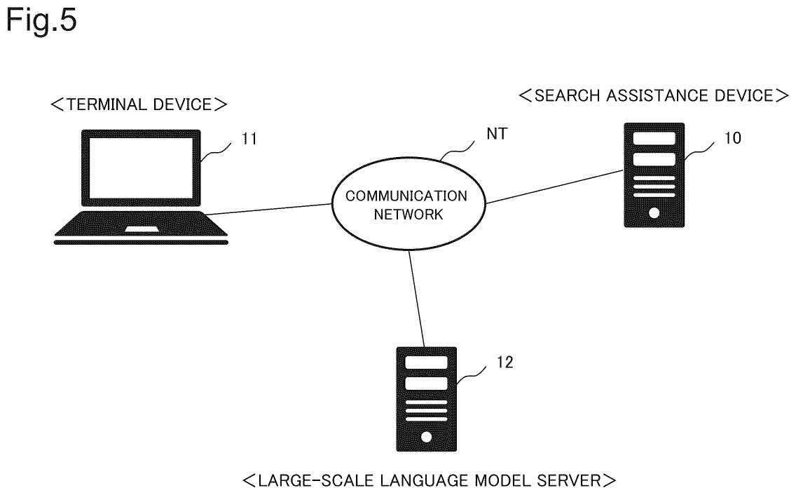

FIG. 5 is an explanatory diagram illustrating an example of connection between the search assistance device 10 and another device. The search assistance device 10 is a system that assists a search for an HS code. For example, the search assistance device receives an operation of a user or presents information to the user via a terminal device 11. For example, the search assistance device 10 is connected to the terminal device 11 via a communication network NT.

For example, the terminal device 11 may be capable of displaying information from the search assistance device 10, or an application program for transmitting information to the search assistance device 10 may be installed in advance in the terminal device 11. For example, the terminal device 11 may access a site of the search assistance device 10 that is a website via the communication network NT.

The type of the terminal device 11 may be a personal computer (PC), a smartphone, a tablet device, or the like, but is not particularly limited thereto. The number of terminal devices 11 may be prepared for each user, and is not particularly limited.

The search assistance device 10 is connected to a large-scale language model server 12 via the communication network NT. The large-scale language model server 12 is a server that executes a process of inputting information to a large-scale language model and outputting an answer from the large-scale language model. The search assistance device 10 transmits a prompt in which a question or the like is described to the large-scale language model server 12. The large-scale language model server 12 inputs the question described in the prompt into the large-scale language model and obtains an answer from the large-scale language model. Then, the large-scale language model server 12 transmits the answer information to the search assistance device 10. The search assistance device 10 may receive the answer information from the large-scale language model server 12. Therefore, the search assistance device 10 can give a question to the large-scale language model and acquire an answer to the question from the large-scale language model.

Although it is illustrated as an example in FIG. 5 that the large-scale language model is used by the large-scale language model server 12, the large-scale language model may be included in the search assistance device 10. In this case, the search assistance device 10 inputs a prompt in which a question is described in the large-scale language model, and obtains an answer to the question from the large-scale language model.

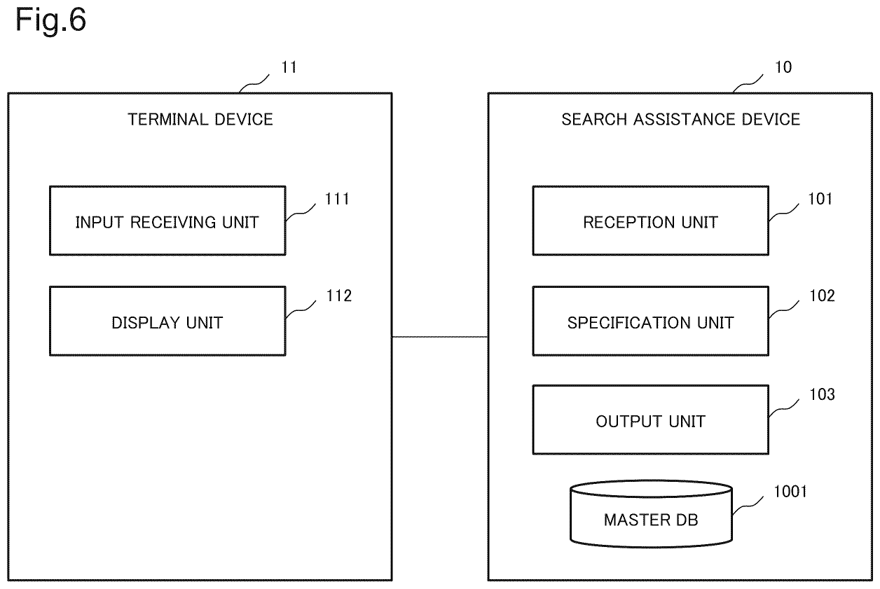

FIG. 6 is a block diagram illustrating configuration examples of the search assistance device 10 and the terminal device 11 according to the present disclosure. For example, the search assistance device 10 includes a reception unit 101, a specification unit 102, and an output unit 103, similarly to the example illustrated in FIG. 3. Further, the search assistance device 10 may include a master DB 1001.

The master DB 1001 includes, for example, HS codes assigned to articles by a user such as a customs officer in the past. For example, the master DB 1001 may store master data in which the HS codes are associated with information related to the import and export of the articles.

The terminal device 11 includes, for example, an input receiving unit 111 and a display unit 112.

Next, each functional unit will be described in more detail.

For example, the reception unit 101 receives a first input related to an article as a search target. The reception unit 101 may further receive a designation of an HS code of a high hierarchy.

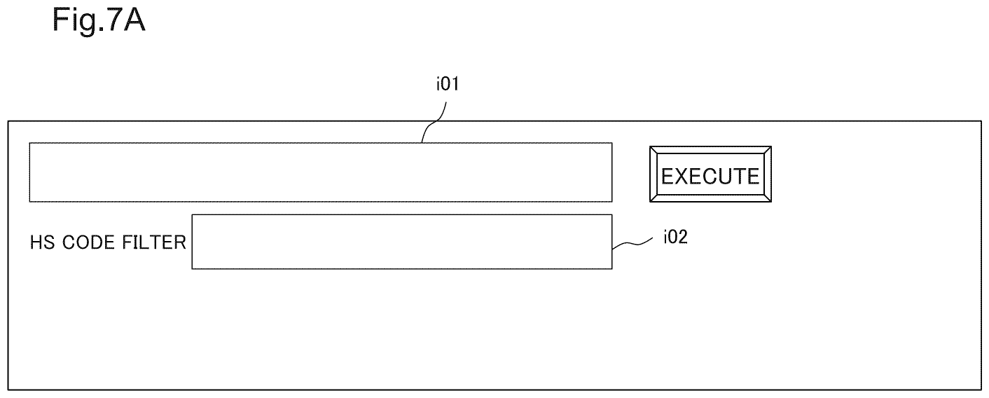

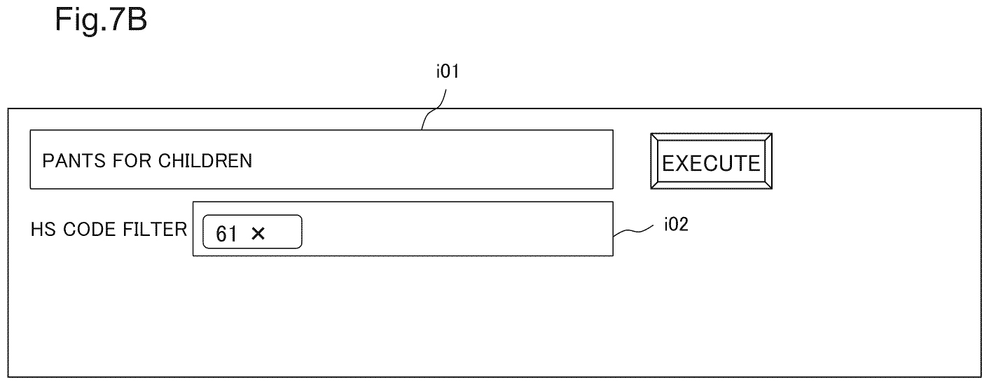

FIG. 7A is an explanatory diagram illustrating an example of a screen capable of receiving a first input. The output unit 103 outputs a screen including a field for inputting a first input to the user terminal. Then, for example, the display unit 112 of the user terminal displays the screen including the field for inputting the first input according to the control by the output unit 103. For example, although the information received as the first input is not limited to a keyword, the first input is also referred to as a keyword input as an example. As an example, the field for inputting the first input is referred to as a keyword input field i01.

The screen further includes an input field in which a designation of an HS code candidate for a higher hierarchy can be input. In FIG. 7A, the input field in which a designation of an HS code candidate for a higher hierarchy can be input is an HS code filter input field i02. For example, the HS code candidate for the higher hierarchy is an HS code candidate for a chapter hierarchy. The screen further includes an execution button. The designated HS code candidate for the higher hierarchy is also referred to as an HS code filter.

FIG. 7B is an explanatory diagram illustrating an example of a screen to which the first input and the HS code of the higher hierarchy are input. When the execution button is pressed, the input receiving unit 111 of the user terminal receives information input in the keyword input field i01 as the first input, and receives information input in the input field i02 as the HS code filter. Then, the input receiving unit 111 transmits the received first input and HS code filter to the search assistance device 10. Then, the reception unit 101 of the search assistance device 10 receives the first input and the HS code filter by receiving the first input and the HS code filter from the terminal device 11.

Transmission and reception of detailed information between the input receiving unit 111 of the user terminal and the reception unit 101 of the search assistance device 10 will be omitted in the following description. In addition, for example, when the output unit 103 causes the user terminal to displays a screen, the display unit 112 displays the screen on the user terminal, and detailed description of the operation between the output unit 103 and the display unit 112 will also be omitted.

In FIG. 7B, the reception unit 101 receives “children's pants” as the keyword input, and receives an HS code “61” for a chapter as the HS code filter.

Next, the specification unit 102 specifies an HS code candidate into which the search target is classified based on the first input and classification information for each HS code included in the HS code group having the hierarchical structure. The classification information is as described in the first example embodiment. Here, an example will be described in which the specification unit 102 specifies an HS code candidate using a large-scale language model.

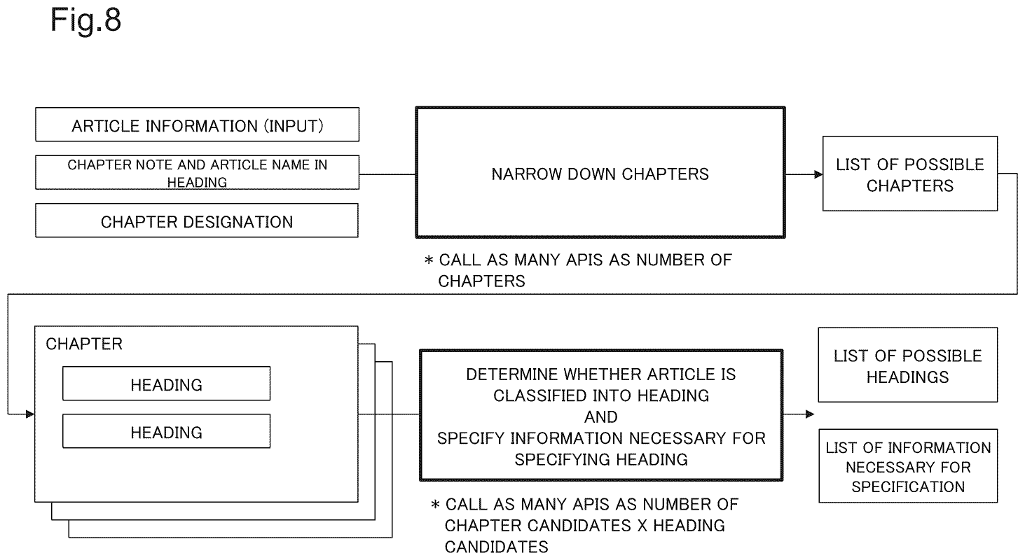

FIG. 8 is an explanatory diagram illustrating a schematic example of a process of specifying an HS code candidate. In FIG. 8, the specification unit 102 narrows down headings after narrowing down chapters based on the article information. In FIG. 8, the article information is a first input. For example, chapter designation means that a chapter is designated by an HS code filter. That is, the HS code filter is an HS code candidate for a chapter hierarchy.

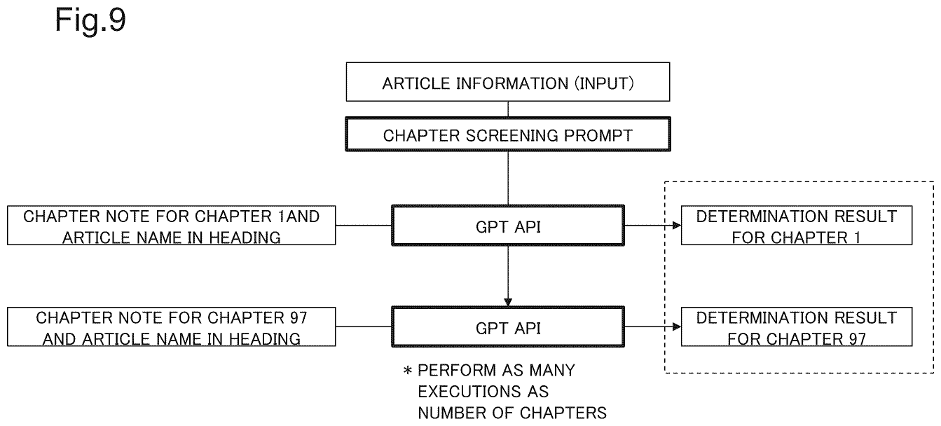

First, in a case where an HS code filter has not been received, the specification unit 102 narrows down chapters. Here, an example will be described in which the specification unit 102 inputs a prompt to the large-scale language model using an application programming interface (API). The specification unit 102 calls as many APIs as the number of chapters. Then, by inputting a chapter note for each chapter, articles in headings included in the chapter, and a first input, the specification unit 102 causes the large-scale language model to determine whether the article indicated by the first input is classified into an HS code of a chapter via the API. For example, the specification unit 102 acquires a list of chapters into which the article as the search target is likely to be classified from the large-scale language model. The process of narrowing down chapters will be described with reference to FIG. 9.

FIG. 9 is an explanatory diagram illustrating an example in which an HS code candidate for a chapter hierarchy is specified using a large-scale language model. Since the GPT is taken as an example of the large-scale language model, the API is expressed as a GPT API in each drawing. As described above, for example, the specification unit 102 calls as many APIs as the number of chapters. In a chapter screening prompt, for example, an instruction is described to cause the large-scale language model to determine an HS code for deciding a tariff rate at the time of importing or exporting an article. Here, the instruction may be described, for example, in the form of a question. That is, the causing of the large-scale language model to determine the HS code of the chapter for deciding the tariff rate at the time of importing and exporting the article may mean that the large-scale language model is caused to answer the question described in the chapter screening prompt. The instruction described in each prompt may similarly be described in the form of a question.

For example, an instruction to a large-scale language model such as “Determine if the article falls under the HS code.” may be described in the chapter screening prompt. For example, the chapter screening prompt may be described in such a way as to input a first input as the article information, a chapter note as the description of the HS code, and article names in headings included in a hierarchy lower than the HS code of the chapter. In the chapter screening prompt, an instruction to cause the large-scale language model to output whether the article is highly likely to be classified into the HS code of the chapter may be described.

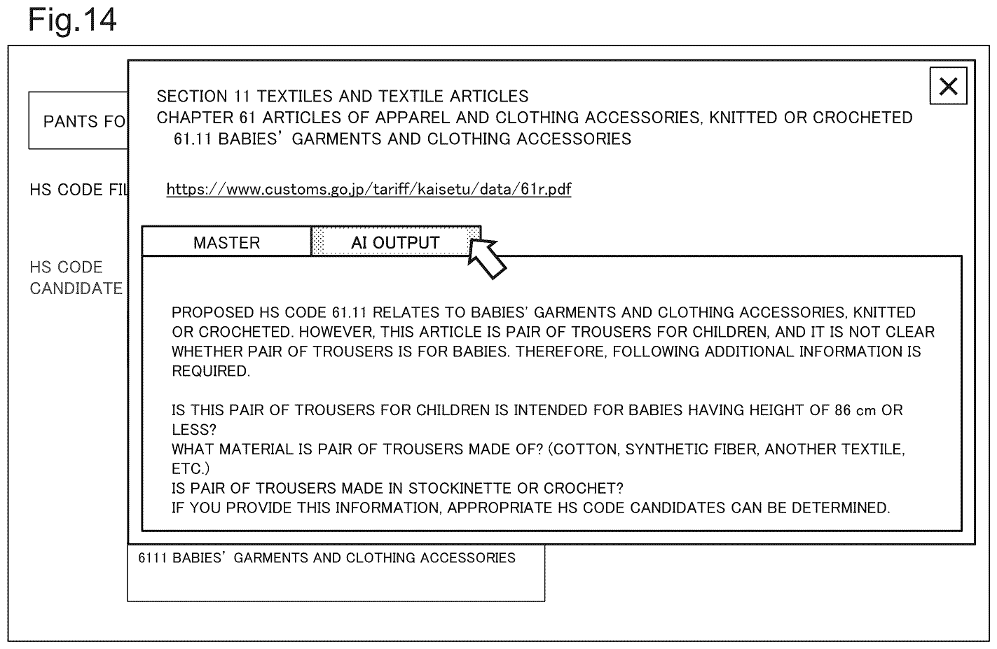

Taking Chapter “1” as an example, the specification unit 102 inputs a chapter note, article names in headings, and the information of the article as the search target, which is a first input, for Chapter “1” in the chapter screening prompt, gives the chapter screening prompt to an API for Chapter “1”, and causes the large-scale language model to determine whether the article as the search target is likely to be classified into Chapter “1”. For example, the specification unit 102 acquires a determination result as to whether the article as the search target is likely to be classified into Chapter “1” from the large-scale language model. Note that an “AI output” as illustrated in FIG. 14 to be described below is an example in which a specific determination result is output from the large-scale language model. More specifically, for example, the specification unit 102 transmits the chapter screening prompt to the large-scale language model server 12 via the API, and the large-scale language model server 12 inputs the chapter screening prompt to the large-scale language model. Then, the large-scale language model server 12 acquires a determination result as to whether the article as the search target is likely to be classified into Chapter “1” from the large-scale language model, and transmits the determination result for Chapter “1” to the search assistance device 10. As a result, by receiving the determination result for Chapter “1”, the specification unit 102 can acquire the determination result for Chapter “1” from the large-scale language model.

The specification unit 102 may perform the same process for each of Chapter 2 to Chapter 97. For example, the specification unit 102 may generate a list of chapters into which it is determined that the article as the search target is highly likely to be classified, among the determination results for the respective chapters.

In the example of FIG. 9, the specification unit 102 executes a process of causing the large-scale language model to make as many determinations as the number of chapters in parallel. As a result, the processing time can be shortened. The specification unit 102 may execute the process of causing the large-scale language model to make determinations, for example, in series. For example, in a case where the specification unit 102 may execute the process of causing the large-scale language model to make determinations in series, determination results obtained so far may be given as an input for a next determination. As a result, determination accuracy can be improved. The specification unit 102 may combine parallel determinations and series determinations, and the method of executing the determination process is not particularly limited. Note that, although the specification unit 102 executes the process of causing the large-scale language model to make determinations in parallel for all the chapters in the example of FIG. 9 because the large-scale language model taken as an example is capable of reading a small amount of data at one time, the specification unit 102 may execute the process of causing the large-scale language model to make determinations in a lump if the large-scale language model is capable of reading a large amount of data at one time.

The output unit 103 may output a “list of possible chapters” illustrated in FIG. 8, which is an intermediate result, to the terminal device 11 of the user.

Returning to the description with reference to FIG. 8, in a case where an HS code filter is received, in other words, in a case where an HS code of a chapter is designated, the specification unit 102 does not need to perform the process of narrowing down chapters. When “61” is designated as illustrated in FIG. 7B, the specification unit 102 does not perform the process of narrowing down chapters. That is, in FIG. 8, when an HS code candidate for a chapter is designated by the HS code filter, the large-scale language model for narrowing down chapters is not used. For example, there is a case where the higher the number of times the large-scale language model is used, the higher the charge. In such a case, by designating an HS code candidate for a chapter, it is possible to achieve cost reduction regarding the use of the large-scale language model. In addition, for example, in a case where the search assistance device 10 is implemented by a local server or the like and the local server has a large-scale language model, it is assumed that resources such as a processor and a memory are limited. In this case, it is expected that the search assistance device 10 cannot perform the processes in parallel, or the number of processes that can be performed in parallel is small even if the processes can be performed in parallel. Therefore, in a case where the search assistance device 10 has a large-scale language model as described above, it is possible to shorten the processing time by specifying an HS code candidate for a chapter using the HS code filter.

In a case where a plurality of HS codes for a chapter is designated, the specification unit 102 may perform the narrowing-down process for each of the plurality of designated chapters.

Next, after narrowing down chapters, or when the HS code candidates for the chapter are designated, the specification unit 102 calls as many APIs as the number of chapters that are HS code candidates. Then, for each of the chapters that are HS code candidates, the specification unit 102 causes the large-scale language model to determine whether the article as the search target is classified into a heading in a hierarchy lower than the chapter that is the HS code candidate via the API. Furthermore, the specification unit 102 causes the large-scale language model to specify information necessary for specifying whether the article as the search target is classified into the heading in the hierarchy lower than the chapter that is the HS code candidate via the API.

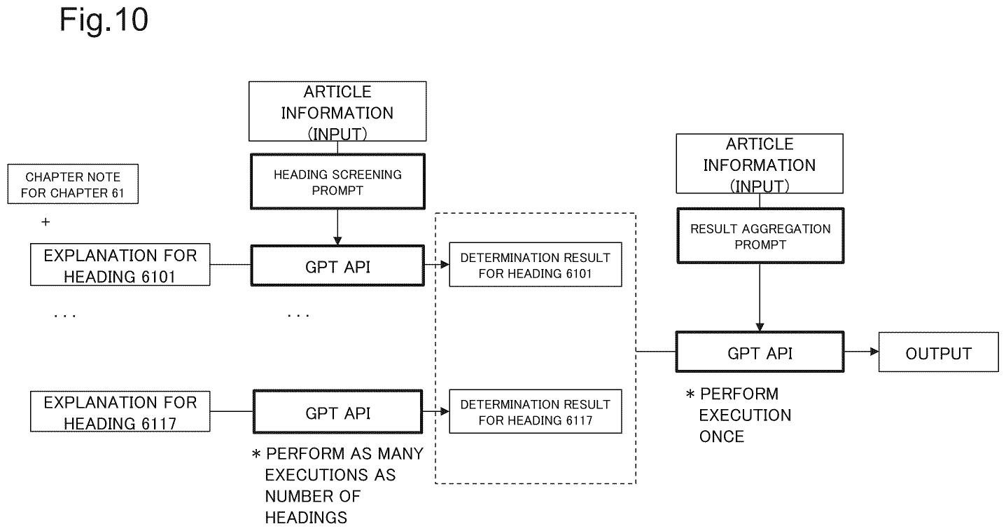

FIG. 10 is an explanatory diagram illustrating an example in which an HS code candidate for a heading hierarchy is specified using a large-scale language model. Assuming that “61” is specified as an HS code candidate for a chapter hierarchy as an example, an example in which an HS code candidate for a heading hierarchy, which is a hierarchy lower than the chapter “61”, is specified will be described.

For example, the specification unit 102 calls APIs for the number of headings in the hierarchy lower than the narrowed-down chapter. For example, the HS codes for headings, which are hierarchies lower than the chapter “61” include “6101” to “6117”. That is, 17 APIs are called.

In a heading screening prompt, for example, an instruction is described to cause the large-scale language model to determine an HS code for deciding a tariff rate at the time of importing or exporting an article. As described above, the instruction may be described, for example, in the form of a question. That is, the causing of the large-scale language model to determine the HS code of the heading for deciding the tariff rate at the time of importing and exporting the article may mean that the large-scale language model is caused to answer the question described in the heading screening prompt.

For example, an instruction to a large-scale language model such as “Determine if the article falls under the HS code of the heading.” may be described in the heading screening prompt. For example, the heading screening prompt may be described in such a way as to input a first input as the article information, a chapter note as the description of the HS code, and an explanation for a heading. In addition, in the heading screening prompt, an instruction for causing the large-scale language model to output whether the article is highly likely to be classified into the heading may be described.

For example, in the heading screening prompt, an instruction to output a reason when the article is not likely to be classified into the heading may be described. For example, in the heading screening prompt, an instruction to output a reason when the article is highly likely to be classified into the heading may be described.

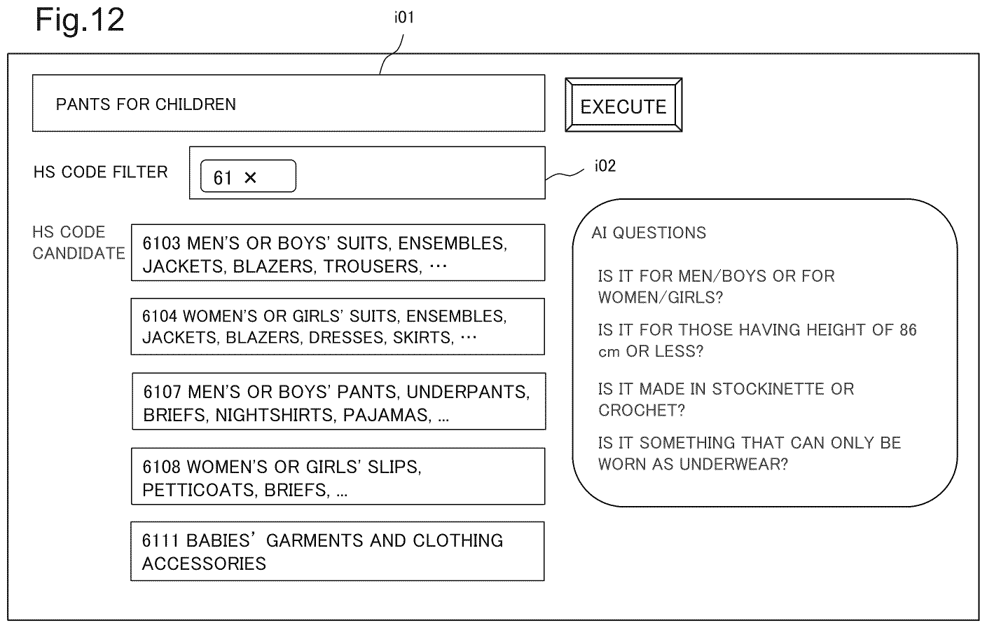

Furthermore, for example, in a case where the information for determining whether the article is classified into the heading is insufficient, an instruction to output information for requesting an additional input of information necessary for specification may be described in the heading screening prompt. Here, the information requesting the additional input is first information that is described in the first example embodiment. The information requesting the additional input may be output in the form of a question. The information requesting the additional input corresponds to, for example, an AI question illustrated in FIG. 12 to be described below.

Then, for each of the HS codes of the headings, the specification unit 102 inputs a chapter note for Chapter “61”, an explanation for the heading, and the article information, which is a first input, to the heading screening prompt, gives the heading screening prompt to an API, and causes the large-scale language model to determine whether the article as the search target is likely to be classified into the heading. Furthermore, the specification unit 102 causes the large-scale language model to determine information necessary for specifying whether the article as the search target is classified into the HS code of the heading. More specifically, for example, the specification unit 102 transmits the heading screening prompt to the large-scale language model server 12 via the API, and the large-scale language model server 12 inputs the heading screening prompt to the large-scale language model. Then, the large-scale language model server 12 acquires, from the large-scale language model, a determination result including answer information as to whether the article as the search target is likely to be classified into the HS code of the heading, information necessary for specifying whether the article as the search target is classified into the HS code of the heading, and the like. The large-scale language model server 12 transmits the determination result to the search assistance device 10. As a result, by receiving each piece of information, the specification unit 102 can acquire the determination result from the large-scale language model.

Here, the HS code candidates include an HS code into which it is determined that the search target is highly likely to be classified and an HS code into which it is determined that information is insufficient in determining whether the search target is classified.

The information necessary for specification may overlap. Therefore, the specification unit 102 inputs the determination result for each heading to a result aggregation prompt to cause the large-scale language model to aggregate the determination results. In the result aggregation prompt, an instruction to aggregate the determination results for the HS code candidates may be described. For example, in the result aggregation prompt, an instruction to output a list of candidate headings and information necessary for specification may be described. The specification unit 102 may store information in which a heading is associated with information necessary for specifying the heading.

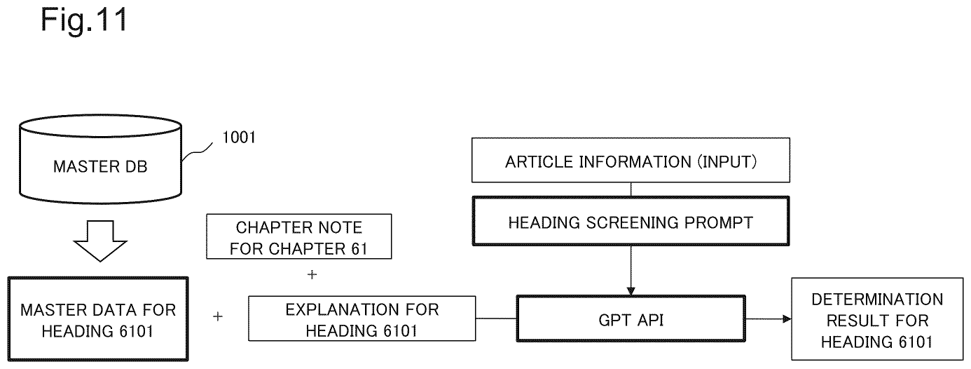

FIG. 11 is an explanatory diagram illustrating another example in which an HS code candidate for a heading hierarchy is specified using a large-scale language model. The specification unit 102 may further give a master DB 1001 to the large-scale language model when causing the large-scale language model to determine whether the article as the search target is classified into the heading. In FIG. 11, in a case where the large-scale language model is caused to determine whether the article is classified into Heading “6101”, for example, the specification unit 102 inputs master data indicating that article are classified into Heading “6101” in the master DB 1001, a chapter note for Chapter “61”, an explanation for Heading “6101”, and the article information to a heading screening prompt. Then, the specification unit 102 inputs the heading screening prompt to the large-scale language model via an API. By using the master DB 1001, the specification unit 102 can easily classify an article, even if the article is not described in the explanations for the headings. For example, it is possible to classify even a new article name or the like that is not described in the applied Customs Tariff Schedule.

Next, in a case where a plurality of HS code candidates can be specified, the output unit 103 outputs first information requesting a second input related to the search target to be additionally input and the HS code candidates. As described above, the first information may be information representing a question necessary for specifying whether the article as the search target is classified into the HS code candidate. The first information may be a question. The output unit 103 displays the HS code candidates and the first information on the terminal device 11. The output unit 103 may display the HS code candidates and the first information on the same screen of the user terminal.

FIG. 12 is an explanatory diagram illustrating an example in which an HS code candidate and an artificial intelligence (AI) question are displayed on the same screen. In FIG. 12, HS code candidates and AI questions are displayed on the screen. The AI questions are questions represented by the aforementioned first information.

For example, in a case where the article as the search target is a pair of pants that is a suit for children, if the article is a suit for men/boys, the article is classified into Heading “6103”, and if the article is for women/girls, the article is classified into Heading “6104”. Therefore, the AI questions include a question such as “Is it for men/boys or for women/girls?”.

Furthermore, for example, in a case where the article as the search target is a garment for babies having a height of 86 cm or less, the article as the search target is classified into Heading “6111”. Therefore, the AI questions include a question such as “It is for those having a height of 86 cm or more?”.

The output unit 103 may output information related to the HS code candidate for the HS code candidate. Examples of the information related to HS code candidate for the heading include information related to a hierarchy higher than the heading, information related to a hierarchy lower than the heading, link information for an explanation for the heading, a determination result obtained from the large-scale language model, and the master DB 1001. For example, the information related to the hierarchy higher than the heading or the information related to the hierarchy lower than the heading may be an HS code itself or an article name associated to the HS code, and is not particularly limited. For example, the link information indicates a link to PDF data on the explanation for the heading.

Specifically, for example, when the input receiving unit 111 receives a user's operation of clicking an HS code candidate, the reception unit 101 receives an instruction to output detailed information. Then, the output unit 103 outputs information related to a hierarchy higher than the heading and a hierarchy lower than the heading, link information for an explanation for the heading, a determination result obtained from the large-scale language model, and the master DB 1001 for the clicked HS code candidate.

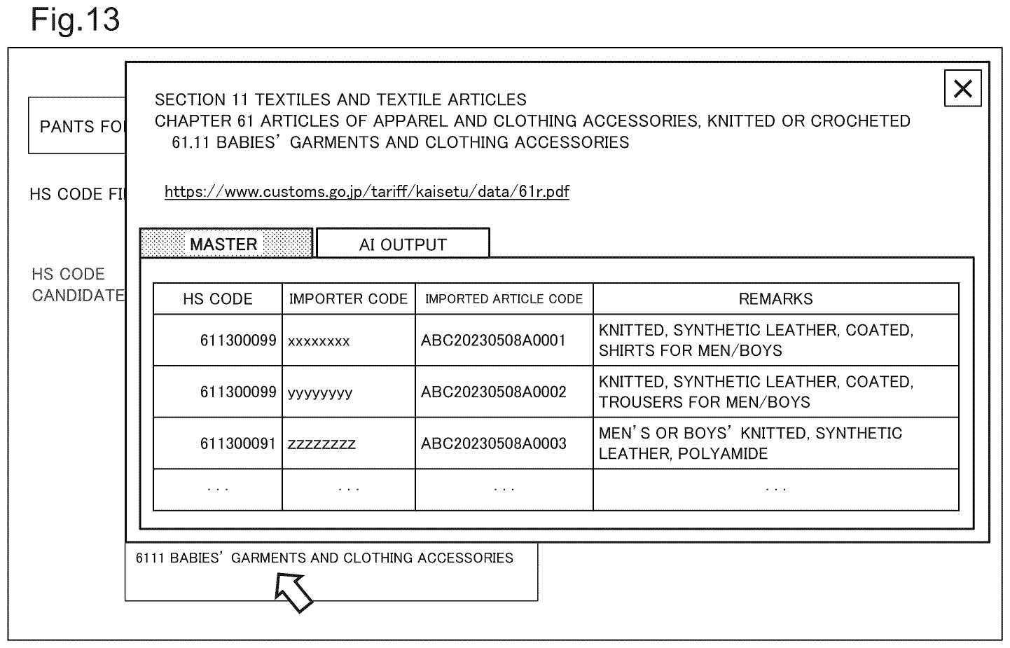

FIG. 13 is an explanatory diagram illustrating Example 1 in which detailed information related to Heading “6111” is displayed. For example, when Heading “6111” is clicked, the output unit 103 displays a screen including information related to Heading “6111” in a superimposed manner on the screen illustrated in FIG. 12.

In FIG. 13, Chapter “61” and Section “11”, which are hierarchies higher than Heading “6111”, and article names in Chapter “61” and article names in Section “11” are displayed on the screen. The selected Heading “6111” and article names in Heading “6111” are displayed on the screen.

In FIG. 13, link information for an explanation for Heading “61.11” published on the Japan Customs website is displayed on the screen. For example, when he input receiving unit 111 detects an operation of clicking a link indicated by the link information, the output unit 103 may display the linked website on the terminal device 11.

In FIG. 13, on the screen, a master and an AI output can be selected, and the master is selected. Therefore, the master DB 1001 is displayed on the screen. The master DB 1001 for articles classified in the past into the operated Heading “6111” may be displayed on the screen.

FIG. 14 is an explanatory diagram illustrating Example 2 in which detailed information related to Heading “6111” is displayed. In FIG. 14, on the screen, a master and an AI output can be selected, and the AI output is selected. Therefore, a determination result for a heading output from the large-scale language model in the specification unit 102 is displayed on the screen as an AI output.

The description will be made with reference to FIG. 12 back. For example, the output unit 103 may output second information indicating a reason why a second input requested by the question that is the first information is necessary. The second information may include an HS code candidate related to the first information and article names in the HS code candidate.

For example, for each question, the question may be associated with an HS code of a heading for which the question has occurred. For example, the question DB may store question identification information for identifying a question, a question, and an HS code of a heading in association with each other. The question identification information is not particularly limited as long as a question can be uniquely identified like a question identifier (ID).

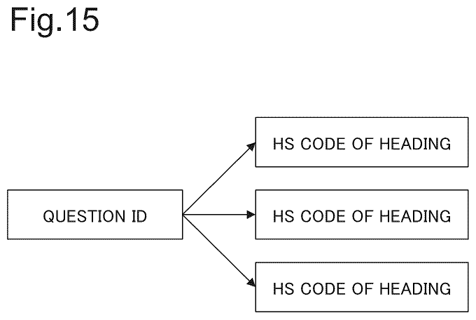

FIG. 15 is an explanatory diagram illustrating an example in which an HS code of a heading is associated with a question ID. In FIG. 15, a question ID of a question that is the first information is associated with HS codes of headings for the question has occurred.

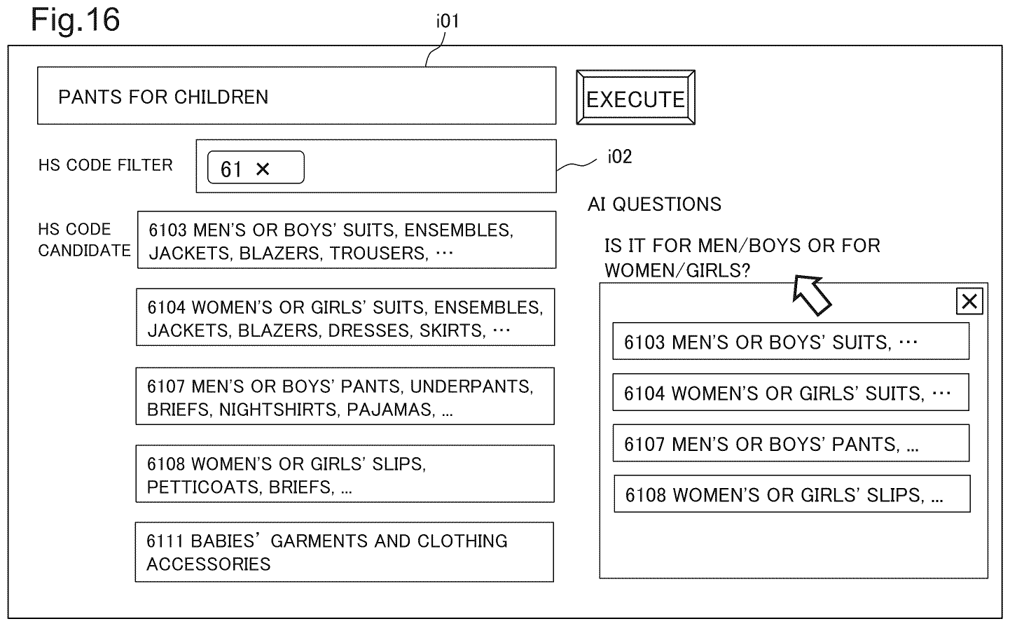

FIG. 16 is an explanatory diagram illustrating an example in which second information indicating a reason why a second input requested by a question is necessary is displayed. For example, when the input receiving unit 111 receives an operation of clicking an AI question “Is it for men/boys or for women/girls?”, the reception unit 101 receives an instruction to output second information. Then, the output unit 103 displays an HS code of a heading and article names in the heading as the second information indicating the reason why the second input requested by the clicked question is necessary. More specifically, for example, the output unit 103 specifies an HS code of a heading associated with the question ID for identifying the clicked question in the question DB, and displays the specified HS code of the heading and article names in the heading on the screen.

In FIG. 16, headings “6103”, “6104”, “6107”, and “6108” and article names therein are displayed on the screen.

The second information may be an explanation for a heading. The second information may be a determination result for a heading as illustrated in FIG. 14.

Returning to the description with reference to FIG. 12, for example, the user may perform a second input related to the article as the search target in the keyword input field i01 in the form of an answer to an AI question. For example, “for men/boys”, “86 cm or less”, and the like may be input next to “children's pants”. When the input receiving unit 111 receives a press of the execution button, the reception unit 101 receives the second input. Then, the specification unit 102 newly specifies an HS code candidate based on the first input, the additional second input, and the classification information for each HS code included in the HS code group having the hierarchical structure. The HS code candidate is as described above. In addition, in a case where a plurality of HS code candidates can be specified by the specification unit 102, the output unit 103 may output outputs first information related to the HS code candidates and requesting a second input related to the search target to be additionally input and the HS code candidates.

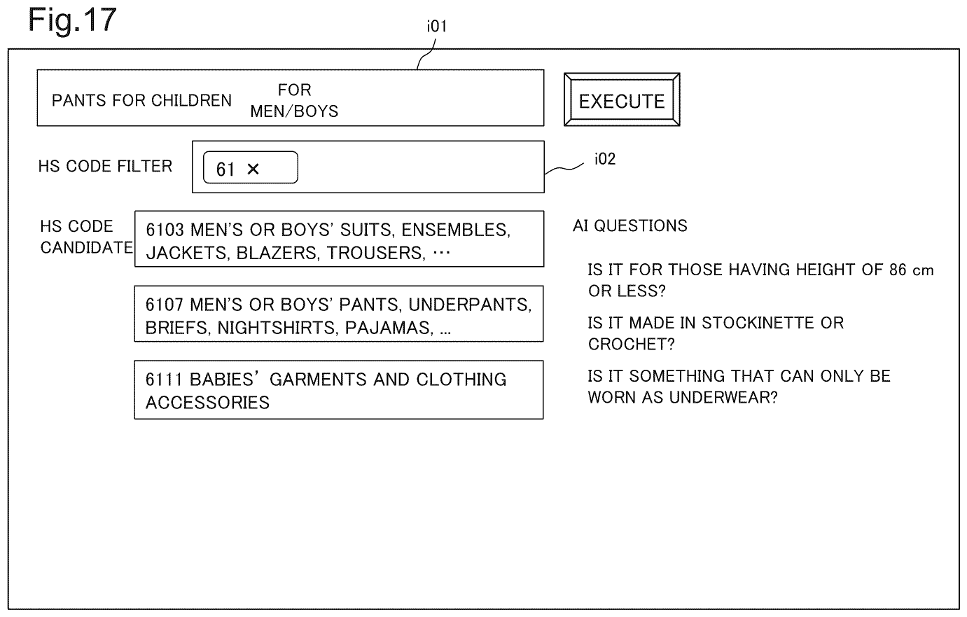

FIG. 17 is an explanatory diagram illustrating an example in which an HS code candidate is displayed when a second input, which is an answer to a question, is input. In FIG. 17, the second input is “for men/boys” that is newly added. The number of HS code candidates on the screen illustrated in FIG. 17 is smaller than that on the screen illustrated in FIG. 12.

Here, an example of a flow of a user's use will be briefly described. For example, the user may input article information related to the search target and an HS code filter for a chapter, which may be initially incomplete, as illustrated in FIG. 7B. Then, when the execution button is pressed, the search assistance device 10 calls an API for a heading in a hierarchy lower than the chapter input to the HS code filter to cause the large-scale language model to determine whether the search target is classified into the heading. The search assistance device 10 displays, on the screen, an HS code candidate and first information requesting an additional input of information necessary for determining whether the search target is classified into the HS code candidate. Then, in a case where there are many AI questions, the user inputs an answer to an AI question in the keyword input field i01 and presses the execution button. Every time the execution button is pressed, the search assistance device 10 executes a process of causing the large-scale language model to determine whether the search target is classified into the heading based on the input made in the keyword input field i01. For example, when the number of AI questions decreases, the user may perform an operation of clicking the HS code candidates to determine a final HS code while referring to the master DB 1001 or the AI output as illustrated in FIG. 13 or 14.

Here, if the second input is an input in the keyword input field i01, every time the execution button is pressed, the specification unit 102 executes a process of causing the large-scale language model to determine whether the search target is classified into the heading for each of the HS codes of the headings lower than the chapter specified by the HS code filter input in the input field i02.

The output unit 103 may display a first region capable of receiving a first input and a second region capable of receiving a second input, the second region being different from the first region. Then, the reception unit 101 may receive information input to the second region as a second input, which is additional information related to the search target.

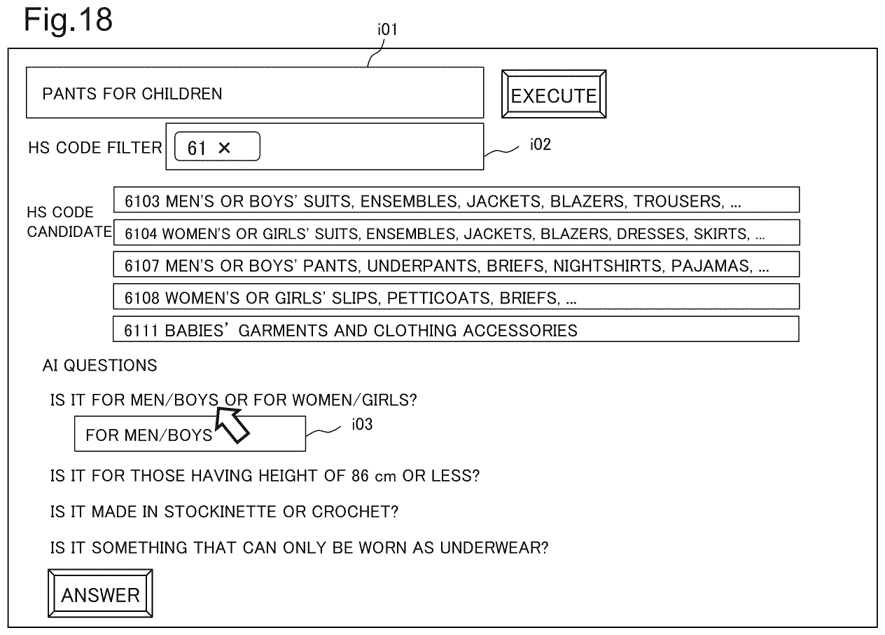

FIG. 18 is an explanatory diagram illustrating an example in which a screen including an answer input field for a question is displayed. In FIG. 18, the keyword input field i01 in which “children's pants” is input is a first region capable of receiving a first input.

In FIG. 18, when the input receiving unit 111 receives an operation of clicking a question, which is first information, the output unit 103 displays an answer input field i03 for the question. The answer input field i03 is a second region capable of receiving a second input.

Similarly for the other questions, when the input receiving unit 111 receives an operation of clicking a question, the output unit 103 may display an answer input field i03 for the question.

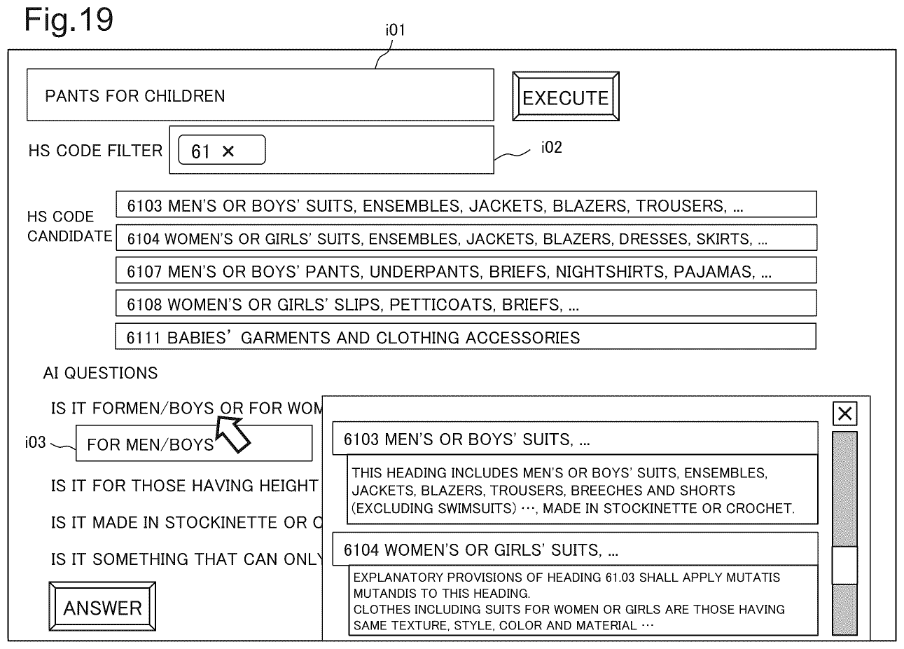

FIG. 19 is an explanatory diagram illustrating an example in which an answer input field for a question and information related to a heading for which the question has occurred are displayed. In FIG. 19, when the input receiving unit 111 receives an operation of clicking a question, the output unit 103 may display an HS code of a heading that is a reason why the question has occurred, article names in the heading, and an explanation for the heading, together with an answer input field i03 for the question. An answer “for men/boys” is input in the answer input field i03. The input to the answer input field i03 is a second input.

Returning to the description with reference to FIG. 18, the screen further includes an answer button. When the answer button is pressed, the input receiving unit 111 receives information (second input) input in the answer input field i03. Then, the reception unit 101 receives the second input by receiving the second input made in the answer input field i03 from the terminal device 11.

Then, the specification unit 102 newly specifies an HS code candidate based on the second input and the classification information for the HS code candidate related to the first information requesting the second input. That is, the specification unit 102 further narrows down the HS code candidates from the HS code candidates. Specifically, for example, by associating questions and HS codes of headings in advance as illustrated in FIG. 15, the specification unit 102 can specify an association relationship between a second input made in an answer input field i03 for a question and first information representing the question. The specification unit 102 may call an API for the heading for which the question to which the answer has been received has occurred, and executes a process of causing the large-scale language model to determine whether the article as the search target is classified into the heading. As a result, it is possible to reduce the number of processes of causing the large-scale language model to make determinations after the second determination. For example, in a case where the determining processes are executed in series, the processing time can be shortened. Furthermore, in a case where the charge for using the large-scale language model increases as the number of processes increases, the cost can be reduced by decreasing the number of determining processes.

The output unit 103 may output the first information in the form of a chat. For example, when the user replies such as “Why do you ask such a question?”, the output unit 103 may output a reason for the second information. Furthermore, for example, the output unit 103 may sequentially output questions that are the first information. Specifically, for example, when the reception unit 101 receives an answer (second input) to a question, the output unit 103 may output a next question.

In the above description, the example in which an HS code candidate for a heading hierarchy is specified has been described. For example, the specification unit 102 may specify an HS code candidate for a sub-heading hierarchy by using the master DB 1001.

In a case where there is a plurality of HS code candidates, for example, among an HS code candidate into which it is determined that the search target is highly likely to be classified and an HS code candidate into which it is determined that information is insufficient in determining whether the search target is classified, the output unit 103 may preferentially display the HS code candidate into which it is determined that the search target is highly likely to be classified. As an example of preferential display, for example, the output unit 103 may display an HS code candidate into which it is determined that the search target is highly likely to be classified and an HS code candidate into which it is determined that information is insufficient in determining whether the search target is classified in this order. As an example of preferential display, for example, the output unit 103 may display an HS code candidate into which it is determined that the search target is highly likely to be classified, and may not display an HS code candidate into which it is determined that information is insufficient in determining whether the search target is classified.

In a case where there is a plurality of HS code candidates, the output unit 103 may display the plurality of HS code candidates in numerical order. In this way, the method of displaying the plurality of HS code candidates is not particularly limited.

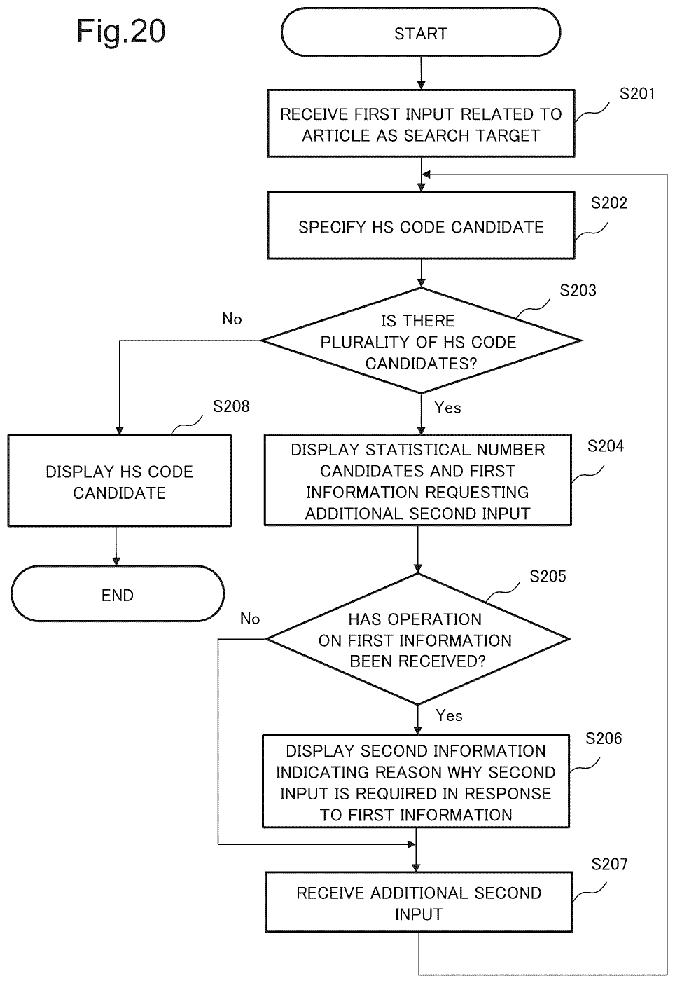

FIG. 20 is a flowchart illustrating an operation example of the search assistance device 10. The reception unit 101 receives a first input related to an article as a search target (step S201). For example, the reception unit 101 may receive an input in a keyword input field i01 as the first input. In step S201, the reception unit 101 may further receive an input in a filter input field for an HS code filter.

Next, the specification unit 102 an HS code candidate, using a large-scale language model, based on the first input and classification information for each HS code (step S202). In step S202, the specification unit 102 may specify first information requesting an additional second input using the large-scale language model. The first information may be information representing a question. The second input may be an answer to the question.

The output unit 103 determines whether a plurality of HS code candidates has been specified by the specification unit 102 (step S203). When the HS code candidates are narrowed down to the heading hierarchy using the large-scale language model, in step S203, the output unit 103 may determine whether a plurality of HS code candidates has been specified for the heading hierarch. When the HS code candidates are narrowed down to the sub-heading hierarchy using the large-scale language model, in step S203, the output unit 103 may determine whether a sole HS code candidate has been specified.

On the other hand, in a case where a plurality of HS code candidates is specified (step S203: Yes), the output unit 103 displays the HS code candidates and first information requesting an additional second input on the terminal device 11 (step S204). For example, the first information represents a question used to specify whether the article as the search target is classified into the HS code candidate. The second input is an answer to the question.

Next, the reception unit 101 determines whether an operation on the first information has been received (step S205). In step S205, for example, the reception unit 101 may determine whether an operation of clicking a question has been received as illustrated in FIG. 18.

When the operation on the first information has been received (step S205: Yes), the output unit 103 displays second information indicating a reason why a second input in response to the first information is required on the terminal device 11 (step S206). When the operation on the first information has not been received (step S205: No), or after step S206, the reception unit 101 receives a second input (step S207). After step S207, the search assistance device 10 returns to step S202. As a result, the process of narrowing down the HS code candidates is repeatedly performed using a new input.

When a plurality of HS code candidates is not specified (step S203: No), the output unit 103 displays the HS code candidate on the terminal device 11 (step S208), and the search assistance device 10 ends a series of processes.

As described above, in the second example embodiment, the search assistance device 10 further outputs a second information indicating a reason why a second input requested by first information is necessary. The second information includes at least one of an HS code candidate related to the first information, an article name in the HS code candidate, and an explanation for a heading of the HS code candidate related to the first information. As a result, the user can more accurately check what information is required to classify the article as the search target into the presented HS code candidate.

The search assistance device 10 outputs second information according to the operation on the first information. As a result, it is possible to display information indicating a reason why an additional input is required if needed by the user.

The search assistance device 10 displays the HS code candidate and the first information on the same screen. As a result, the user can confirm the HS code candidate and the AI question at a glance.

The search assistance device 10 displays a first region capable of receiving a first input and a second region capable of receiving a second input, the second region being different from the first region. Then, the search assistance device 10 receives information input in each region. As a result, the search assistance device 10 can specify an association relationship between the first information that is an AI question and the second input that is an answer to the question. Then, the search assistance device 10 newly specifies an HS code candidate based on the second input and the classification information for the HS code candidate related to the first information requesting the second input. In this manner, the search assistance device 10 can execute a process of causing the large-scale language model to perform a determination process again with the narrowed-down HS code candidates related to the first information, which is an AI question. Therefore, it is possible to reduce the number of processes of causing the large-scale language model to make determinations. For example, in a case where the determining processes are executed in series, the processing time can be shortened. Furthermore, in a case where the charge for using the large-scale language model increases as the number of processes increases, the cost can be reduced by decreasing the number of determining processes.

The search assistance device 10 specifies an HS code candidate into which the search target is classified further based on information related to HS codes assigned to articles by the user in the past. By using such information, an article can be classified even if the article is not described in the explanations disclosed by Japan Customs. For example, it is possible to classify even a new article name or the like that is not described in the applied Customs Tariff Schedule published by Japan Customs.

The description of each example embodiment ends here. The example embodiments may be combined. In each of the example embodiments, the search assistance device 10 may include some of the functional units and the information.

The description of the application example ends here. Each of the example embodiments is not limited to the examples described above, and various modifications can be made. The configuration of the search assistance device 10 according to the example embodiment is not particularly limited. For example, the functional units of the search assistance device 10 may be achieved by one device. Alternatively, for example, the functional units or DBs of the search assistance device 10 according to the example embodiment may be implemented by different devices and configured as a system. For example, the functional units of the search assistance device 10 may be constituted by a plurality of servers and implemented as a system. For example, the search assistance device 10 may be implemented by a database server including each DB and a server including each functional unit. Each functional unit of the search assistance device 10 may be implemented by a cloud server or the like.

In the example embodiment, each DB may include some of the above-described information. Furthermore, each piece of information may include information other than the above-described information.

The process of generating information or the like to be displayed on the terminal device 11 may be performed by the output unit 103 of the search assistance device 10. his process may be performed by the display unit 112 of the terminal device 11. That is, the terminal device 11 generates information on a screen to be displayed on the terminal device 11 based on the data received from the search assistance device 10, and displays the screen. Each screen is an example, and the positions, colors, sizes, and the like of the input fields, the buttons, and the like may be appropriately changed.

### (Hardware Configuration Example of Computer)

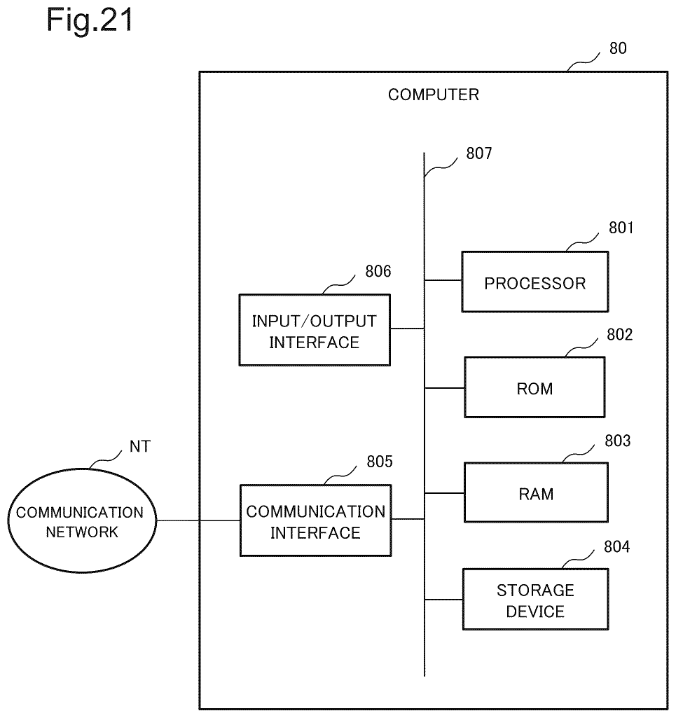

Next, a hardware configuration example in a case where each of the search assistance device 10, the terminal device 11, the large-scale language model server 12, and the like described in the example embodiment is implemented by a computer will be described. FIG. 21 is an explanatory diagram illustrating a hardware configuration example of a computer. For example, some or all of the devices can be implemented by using any combination of the computer 80 as illustrated in FIG. 21 with programs.

The computer 80 includes, for example, a processor 801, a read only memory (ROM) 802, a random access memory (RAM) 803, and a storage device 804. Furthermore, the computer 80 includes a communication interface 805 and an input/output interface 806. These components are connected to each other via, for example, a bus 807. Note that the number of components for each type is not particularly limited, and is one or more.

The processor 801 controls the entire computer 80. As the processor 801, for example, a central processing unit (CPU), a digital signal processor (DSP), a graphics processing unit (GPU), a physics processing unit (PPU), a tensor processing unit (TPU), a quantum processor, a combination thereof, or the like can be used, and is not particularly limited.

In addition, the computer 80 includes a ROM 802, a RAM 803, a storage device 804, and the like. Examples of the storage device 804 include a semiconductor memory such as a flash memory, a hard disk drive (HDD), a solid state drive (SSD), and the like. For example, the storage device 804 stores an operating system (OS) program, an application program, a program according to the example embodiment, and the like. Alternatively, the ROM 802 stores an application program, a program according to the example embodiment, and the like. Then, the RAM 803 is used as a work area of the processor 801.

The processor 801 loads a program stored in the storage device 804, the ROM 802, or the like. Then, the processor 801 executes each process coded in the program. In addition, the processor 801 may download various programs via the communication network NT. The processor 801 functions as some or all of the computer 80. Then, the processor 801 may execute a process or an instruction in the illustrated flowchart based on the program.

The communication interface 805 is connected to the communication network NT such as a local area network (LAN) or a wide area network (WAN) through a wireless or wired communication line. The communication network NT may include a plurality of communication networks NT. By doing so, the computer 80 is connected to an external device or an external computer 80 via the communication network NT. The communication interface 805 serves as an interface between the communication network NT and the inside of the computer 80. Also, the communication interface 805 controls input and output of data from and to an external device or an external computer 80.

The input/output interface 806 is connected to at least one of an input device, an output device, and an input/output device. The connection method may be wireless or wired. Examples of the input device include a keyboard, a mouse, a microphone, and the like. Examples of the output device include a display device, a lighting device, a sound output device that outputs a sound, and the like. Examples of the input/output device include a touch panel display and the like. The input device, the output device, the input/output device, and the like may be built in the computer 80 or may be externally attached to the computer 80.

The hardware configuration of the computer 80 is an example. The computer 80 may have some of the components illustrated in FIG. 21. The computer 80 may have components other than the components illustrated in FIG. 21. For example, the computer 80 may include a drive device or the like. Then, the processor 801 may read a program or data recorded in a recording medium mounted on the drive device or the like to the RAM 803. Examples of the non-transitory recording medium include an optical disk, a flexible disk, a magnetic optical disk, a universal serial bus (USB) memory, and the like. As described above, for example, the computer 80 may include an input device such as a keyboard or a mouse. The computer 80 may include an output device such as a display. Furthermore, the computer 80 may include an input device, an output device, and an input/output device.

The computer 80 may include various types of sensors that are not illustrated. The types of sensors are not particularly limited. Furthermore, the computer 80 may include an imaging device capable of capturing images and videos.

The description of the hardware configuration of each device ends here. There are various modifications to the method for implementing each device. For example, each of the devices may be implemented by any combination of a program with a computer different for each component. Alternatively, a plurality of components included in each of the devices may be implemented by any combination of a program with one computer.

Each component of each device may be partially or entirely implemented by a circuit for specific use. Each component of each device may be partially or entirely implemented by a general-purpose circuit such as a field programmable gate array (FPGA). Each component of each device may be partially or entirely implemented by a combination of a circuit for specific use, a general-purpose circuit, and the like. These circuits may be single integrated circuits. Alternatively, these circuits may be divided into a plurality of integrated circuits. The plurality of integrated circuits may be connected to each other via a bus or the like.

In a case where each component of each device is partially or entirely implemented by a plurality of computers, circuits, or the like, the plurality of computers, circuits, or the like may be arranged in a centralized manner or in a distributed manner.

The search assistance method described in the example embodiment may be implemented when executed by a computer such as the search assistance device 10.

Each program described in the example embodiment, such as a formulation program and an optimization program, is recorded in a computer-readable recording medium such as an HDD, an SSD, a flexible disk, an optical disk, a magnetic optical disk, or a USB memory. Then, each program is executed by the computer when read from the recording medium. Each program may be distributed via the communication network NT.

The function of each component of the search assistance device 10 described above may be implemented by dedicated hardware such as a computer. Alternatively, each component may be implemented by software. Alternatively, each component may be implemented by a combination of hardware and software.

While the present disclosure has been particularly shown and described with reference to the example embodiments thereof, the present disclosure is not limited to these example embodiments. It will be understood by those of ordinary skill in the art that various changes in form and details may be applied to the example embodiments without departing from the spirit and scope of the present disclosure as defined by the claims. The present disclosure may include example embodiments in which the matters described in the present specification are appropriately combined or replaced if necessary. For example, the matters described using a specific example embodiment can be applied to another example embodiment as long as no contradiction occurs. For example, although a plurality of operations is described in order in the form of a flowchart, the order in which the operations are described does not limit an order in which the plurality of operations is executed. Therefore, when the example embodiment is carried out, the order in which the plurality of operations is executed can be changed within a range that does not interfere with the content.

Some or all of the above-described example embodiments can also be described as in the following supplementary notes. However, some or all of the above-described example embodiments are not limited to the following supplementary notes.

### (Supplementary Note 1)

A search assistance device including:
a reception means for receiving a first input related to an article as a search target;
a specification means for specifying a statistical number candidate into which the search target is classified based on the first input and classification information for each statistical number included in a statistical number group having a hierarchical structure; and
an output means for outputting first information requesting a second input related to the search target to be additionally input in a case where a plurality of statistical number candidates is specified by the specification means, and the statistical number candidate.

### (Supplementary Note 2)

The search assistance device according to supplementary note 1, in which
the first information represents a question used to specify whether the search target is classified into the statistical number candidate, and
the second input is an answer to the question.

### (Supplementary Note 3)

The search assistance device according to supplementary note 1 or 2, in which
the output means outputs second information indicating a reason why the second input requested by the first information is necessary.

### (Supplementary Note 4)

The search assistance device according to supplementary note 3, in which
the second information includes at least one of the statistical number candidate related to the first information, an article name in the statistical number candidate, and an explanation for a heading of the statistical number candidate related to the first information.

### (Supplementary Note 5)

The search assistance device according to supplementary note 3, in which
the output means outputs the second information according to an operation on the first information.

### (Supplementary Note 6)

The search assistance device according to any one of supplementary notes 1 to 5, in which
the output means displays a first region capable of receiving the first input and a second region capable of receiving the second input, the second region being different from the first region,
the reception means receives information input in the second region as the second input, and
the specification means newly specifies a statistical number candidate based on the second input and classification information for the statistical number candidate related to the first information requesting the second input.

### (Supplementary Note 7)

The search assistance device according to any one of supplementary notes 1 to 6, in which
the specification means specifies the statistical number candidate into which the search target is classified further based on information related to statistical numbers assigned to articles by a user in the past.

### (Supplementary Note 8)

The search assistance device according to any one of supplementary notes 1 to 7, in which
the output means displays the statistical number candidate and the first information on a same screen.

### (Supplementary Note 9)

The search assistance device according to any one of supplementary notes 1 to 8, in which
in a case where a plurality of statistical number candidates is specified from among statistical numbers included in a heading hierarchy in the statistical number group having the hierarchical structure, the output means outputs the first information and the statistical number candidate.

### (Supplementary Note 10)

The search assistance device according to any one of supplementary notes 1 to 9, in which
the specification means specifies the statistical number candidate and the first information by using a large-scale language model.

### (Supplementary Note 11)

The search assistance device according to supplementary note 10, in which
the specification means inputs a prompt to the large-scale language model, the prompt including the first input, the classification information for each statistical number included in the statistical number group having the hierarchical structure, and question information as to whether the search target is classified into the statistical number, and acquires the statistical number candidate and the first information from the large-scale language model.

### (Supplementary Note 12)

A search assistance method including the steps of, by a computer:
receiving a first input related to an article as a search target;
specifying a statistical number candidate into which the search target is classified based on the first input and classification information for each statistical number included in a statistical number group having a hierarchical structure; and
outputting first information requesting a second input related to the search target to be additionally input in a case where a plurality of statistical number candidates is specified, and the statistical number candidate.

### (Supplementary Note 13)

The search assistance method according to supplementary note 12, in which
the first information represents a question used to specify whether the search target is classified into the statistical number candidate, and
the second input is an answer to the question.

### (Supplementary Note 14)

The search assistance method according to supplementary note 12 or 13, in which
in the outputting step, second information is output, the second information indicating a reason why the second input requested by the first information is necessary.

### (Supplementary Note 15)

The search assistance method according to supplementary note 14, in which
the second information includes at least one of the statistical number candidate related to the first information, an article name in the statistical number candidate, and an explanation for a heading of the statistical number candidate related to the first information.

### (Supplementary Note 16)

The search assistance method according to supplementary note 14, in which
in the outputting step, the second information is output according to an operation on the first information.

### (Supplementary Note 17)

The search assistance method according to any one of supplementary notes 12 to 16, in which
in the outputting step, a first region capable of receiving the first input and a second region capable of receiving the second input are displayed, the second region being different from the first region,
in the receiving step, information input in the second region is received as the second input, and
in the specifying step, a statistical number candidate is newly specified based on the second input and classification information for the statistical number candidate related to the first information requesting the second input.

### (Supplementary Note 18)

The search assistance method according to any one of supplementary notes 12 to 17, in which
in the specifying step, the statistical number candidate into which the search target is classified is specified further based on information related to statistical numbers assigned to articles by a user in the past.

### (Supplementary Note 19)

The search assistance method according to any one of supplementary notes 12 to 18, in which
in the outputting step, the statistical number candidate and the first information are displayed on a same screen.

### (Supplementary Note 20)

The search assistance method according to any one of supplementary notes 12 to 19, in which
in the outputting step, in a case where a plurality of statistical number candidates is specified from among statistical numbers included in a heading hierarchy in the statistical number group having the hierarchical structure, the first information and the statistical number candidate are displayed.

### (Supplementary Note 21)

The search assistance method according to any one of supplementary notes 12 to 20, in which
in the specifying step, the statistical number candidate and the first information are specified by using a large-scale language model.

### (Supplementary Note 22)

The search assistance method according to supplementary note 21, in which
in the specifying step, a prompt is input to the large-scale language model, the prompt including the first input, the classification information for each statistical number included in the statistical number group having the hierarchical structure, and question information as to whether the search target is classified into the statistical number, and the statistical number candidate and the first information are acquired from the large-scale language model.

### (Supplementary Note 23)

A program for causing a computer to execute the processes of:

receiving a first input related to an article as a search target;

specifying a statistical number candidate into which the search target is classified based on the first input and classification information for each statistical number included in a statistical number group having a hierarchical structure; and
outputting first information requesting a second input related to the search target to be additionally input in a case where a plurality of statistical number candidates is specified, and the statistical number candidate.

### (Supplementary Note 24)

The program according to supplementary note 23, in which
the first information represents a question used to specify whether the search target is classified into the statistical number candidate, and
the second input is an answer to the question.

### (Supplementary Note 25)

The program according to supplementary note 23 or 24, in which
in the outputting process, second information is output, the second information indicating a reason why the second input requested by the first information is necessary.

### (Supplementary Note 26)

The program according to supplementary note 25, in which
the second information includes at least one of the statistical number candidate related to the first information, an article name in the statistical number candidate, and an explanation for a heading of the statistical number candidate related to the first information.

### (Supplementary Note 27)

The program according to supplementary note 25, in which
In the outputting process, the second information is output according to an operation on the first information.

### (Supplementary Note 28)

The program according to any one of supplementary notes 23 to 27, in which
in the outputting process, a first region capable of receiving the first input and a second region capable of receiving the second input are displayed, the second region being different from the first region,
in the receiving process, information input in the second region is received as the second input, and
in the specifying process, a statistical number candidate is newly specified based on the second input and classification information for the statistical number candidate related to the first information requesting the second input.

### (Supplementary Note 29)

The program according to any one of supplementary notes 23 to 28, in which
in the specifying process, the statistical number candidate into which the search target is classified is specified further based on information related to statistical numbers assigned to articles by a user in the past.

### (Supplementary Note 30)

The program according to any one of supplementary notes 23 to 29, in which
in the outputting process, the statistical number candidate and the first information are displayed on a same screen.

### (Supplementary Note 31)

The program according to any one of supplementary notes 23 to 30, in which
in the outputting process, in a case where a plurality of statistical number candidates is specified from among statistical numbers included in a heading hierarchy in the statistical number group having the hierarchical structure, the first information and the statistical number candidate are displayed.

### (Supplementary Note 32)

The program according to any one of supplementary notes 23 to 31, in which
in the specifying step, the statistical number candidate and the first information are specified by using a large-scale language model.

### (Supplementary Note 33)

The program according to supplementary note 32, in which
in the specifying step, a prompt is input to the large-scale language model, the prompt including the first input, the classification information for each statistical number included in the statistical number group having the hierarchical structure, and question information as to whether the search target is classified into the statistical number, and the statistical number candidate and the first information are acquired from the large-scale language model.

### (Supplementary Note 34)

A non-transitory computer-readable recording medium recording a program for causing a computer to execute the processes of:
receiving a first input related to an article as a search target;
specifying a statistical number candidate into which the search target is classified based on the first input and classification information for each statistical number included in a statistical number group having a hierarchical structure; and
outputting first information requesting a second input related to the search target to be additionally input in a case where a plurality of statistical number candidates is specified, and the statistical number candidate.

The previous description of embodiments is provided to enable a person skilled in the art to make and use the present disclosure. Moreover, various modifications to these example embodiments will be readily apparent to those skilled in the art, and the generic principles and specific examples defined herein may be applied to other embodiments without the use of inventive faculty. Therefore, the present disclosure is not intended to be limited to the example embodiments described herein but is to be accorded the widest scope as defined by the limitations of the claims and equivalents.

Further, it is noted that the inventor's intent is to retain all equivalents of the claimed invention even if the claims are amended during prosecution.

1. A search assistance device comprising:
at least one memory configured to store instructions; and
at least one processor configured to execute the instructions to:
receive a first input related to an article as a search target;
specify a statistical number candidate into which the search target is classified based on the first input and classification information for each statistical number included in a statistical number group having a hierarchical structure; and
output first information requesting a second input related to the search target to be additionally input in a case where a plurality of statistical number candidates is specified, and the statistical number candidate.

2. The search assistance device according to claim 1, wherein
the first information represents a question used to specify whether the search target is classified into the statistical number candidate, and
the second input is an answer to the question.

3. The search assistance device according to claim 1, wherein the at least one processor is further configured to execute the instructions to:
output second information indicating a reason why the second input requested by the first information is necessary.

4. The search assistance device according to claim 3, wherein
the second information includes at least one of the statistical number candidate related to the first information, an article name in the statistical number candidate, and an explanation for a heading of the statistical number candidate related to the first information.

5. The search assistance device according to claim 3, wherein the at least one processor is further configured to execute the instructions to:
output the second information according to an operation on the first information.

6. The search assistance device according to claim 1, wherein the at least one processor is further configured to execute the instructions to:
display a first region capable of receiving the first input and a second region capable of receiving the second input, the second region being different from the first region;
receive information input in the second region as the second input; and
newly specify a statistical number candidate based on the second input and classification information for the statistical number candidate related to the first information requesting the second input.

7. The search assistance device according to claim 1, wherein the at least one processor is further configured to execute the instructions to:
specify the statistical number candidate into which the search target is classified based on information related to statistical numbers assigned to articles by a user in the past.

8. The search assistance device according to claim 1, wherein the at least one processor is further configured to execute the instructions to:
display the statistical number candidate and the first information on a same screen.

9. The search assistance device according to claim 1, wherein the at least one processor is further configured to execute the instructions to:
in a case where a plurality of statistical number candidates is specified from among statistical numbers included in a heading hierarchy in the statistical number group having the hierarchical structure, output the first information and the statistical number candidate.

10. The search assistance device according to claim 1, wherein the at least one processor is further configured to execute the instructions to:
specify the statistical number candidate and the first information by using a large-scale language model.

11. The search assistance device according to claim 10, wherein the at least one processor is further configured to execute the instructions to:
input a prompt to the large-scale language model, the prompt including the first input, the classification information for each statistical number included in the statistical number group having the hierarchical structure, and question information as to whether the search target is classified into the statistical number, and acquire the statistical number candidate and the first information from the large-scale language model.

12. A search assistance method performed by a computer, the search assistance method comprising the steps of:
receiving a first input related to an article as a search target;
specifying a statistical number candidate into which the search target is classified based on the first input and classification information for each statistical number included in a statistical number group having a hierarchical structure; and
outputting first information requesting a second input related to the search target to be additionally input in a case where a plurality of statistical number candidates is specified, and the statistical number candidate.

13. A non-transitory computer-readable recording medium recording a program for causing a computer to execute the processes of:
receiving a first input related to an article as a search target;
specifying a statistical number candidate into which the search target is classified based on the first input and classification information for each statistical number included in a statistical number group having a hierarchical structure; and
outputting first information requesting a second input related to the search target to be additionally input in a case where a plurality of statistical number candidates is specified, and the statistical number candidate.
